(19) United States
(12) Patent Application Publication
(10) Pub. No.: US 2021/0351402 A1
(43) Pub. Date: Nov. 11, 2021

(54) LITHIUM METAL FOILS WITH LOW DEFECT DENSITY

(71) Applicant: Robert Bosch GmbH, Stuttgart (DE)

(72) Inventors: Timothy Henry Westmore, Foster City, CA (US); Hany Basam EITOUNI, Oakland, CA (US); Almira NUVAL, Freemont, CA (US); Russell Clayton Pratt, San Mateo, CA (US)

(21) Appl. No.: 17/378,297

(22) Filed: Jul. 16, 2021

Related U.S. Application Data
(62) Division of application No. 16/294,896, filed on Mar. 6, 2019.
(60) Provisional application No. 62/640,025, filed on Mar. 8, 2018.

(51) Int. Cl. H01M 4/38; H01M 10/0565; H01M 10/0562; H01M 10/052

(52) U.S. Cl. CPC H01M 4/382; H01M 10/0565; H01M 2004/027; H01M 10/052; H01M 2300/0082; H01M 10/0562

(57) ABSTRACT

Commercially-available lithium metal foils have been found to have a high density of crystalline defects. When such foils are used as the anode in a secondary lithium metal battery cell, repeated cycling may lead to the formation of lithium shunts near the crystalline defects, which can cause shorting. Methods described herein may be used to reduce the density of crystalline defects in lithium metal foils. Such lithium metal can be used as the anode in lithium battery cells.

### CROSS-REFERENCE TO RELATED APPLICATIONS

This application is a division of U.S. application Ser. No. 16/294,896, filed Mar. 6, 2019, which claims the benefit of U.S. Provisional Patent Application 62/640,025, filed Mar. 8, 2018, the disclosures of which are incorporated in their entirety by reference herein.

### BACKGROUND OF THE INVENTION

### Field of the Invention

This invention relates generally to lithium metal, and, more specifically, to lithium metal foils with very low defect density, which are especially useful as anodes in secondary battery cells.

Current practice specifies a purity of about 99.9% for “battery-grade” lithium metal, which is verified through analysis of no more than about 15 elemental impurities. Such battery-grade lithium metal has been used successfully in primary batteries, which discharge once and do not undergo repeated charging and discharging.

In a secondary lithium battery, lithium metal ions leave the negative electrode (anode) and move toward the positive electrode (cathode) during discharge as they do in primary batteries. But, unlike primary batteries, in secondary batteries lithium metal ions move back to the negative electrode during charging. Secondary batteries are designed to undergo very many cycles of charging and discharging.

Currently-available battery-grade lithium metal does not include any specification as to the presence of compounds, second phases, and other morphological defects. But, it has been found that such defects in battery-grade lithium metal adversely affect uniformity in charge transfer at the anode in secondary batteries. Thus, specifications of battery grade-purity have been found to be inadequate as the performance of lithium metal anodes in secondary batteries is affected by defects that are not accounted for in analyses of solute atoms alone.

What is needed is a method to reduce the density of defects in lithium metal and secondary-battery-grade lithium metal specifications that include quantification of such defects.

### SUMMARY

In one embodiment of the invention, a material is described. The material is a lithium metal foil that includes lithium metal and crystalline defects that contain lithium and at least one other element selected from the group consisting of hydrogen, oxygen, and nitrogen. The lithium metal foil contains no more than one crystalline defect with a largest dimension at least as large as the lithium foil thickness per 1.35×10-³ cubic meters (1.35×10⁶ cubic millimeters) of lithium metal foil.

In one embodiment of the invention, a material is described. The material is a lithium metal foil that includes lithium metal and crystalline defects that contain lithium and at least one other element selected from the group consisting of hydrogen, oxygen, and nitrogen. The total surface area of the lithium metal foil includes both a first surface area from a first surface and a second surface area from a second surface opposite the first surface. The lithium metal foil contains no more than one crystalline defect per 0.0074 meter³ of total surface area.

In another embodiment of the invention, a method of reducing defect density in a lithium metal foil is disclosed. The method involves providing molten lithium metal; adding a gettering material to the molten lithium metal; holding the molten lithium metal at a temperature of 550° C. for at least 180 minutes; separating the molten lithium from the getter material by filtration; casting the molten lithium to form an ingot; and extruding the ingot to form a foil. The foil may also undergo rolling to reduce its thickness.

The lithium metal foils described herein can be used as an anode in a lithium battery cell.

In another embodiment of the invention, a lithium battery cell is described. The cell has an anode containing any of the lithium metal foils described herein; a cathode comprising cathode active material particles, an electronically-conductive additive, and a catholyte; a current collector adjacent to an outside surface of the cathode; and a separator region between the anode and the cathode, the separator region comprising a separator electrolyte configured to facilitate movement of lithium ions back and forth between the anode and the cathode.

In some arrangements, at least one of the catholyte and the separator electrolyte contains a solid polymer electrolyte and a lithium salt. In some arrangements, at least one of the catholyte and the separator electrolyte contains a ceramic electrolyte. In some arrangements, the catholyte and the separator electrolyte are the same. The cathode electrode active material may be selected from the group consisting of lithium iron phosphate, lithium metal phosphate, divanadium pentoxide, lithium nickel cobalt aluminum oxide, lithium nickel cobalt manganese oxide, magnesium-rich lithium nickel cobalt manganese oxide, lithium manganese spinel, lithium nickel manganese spinel, and combinations thereof.

### BRIEF DESCRIPTION OF THE DRAWINGS

The foregoing aspects and others will be readily appreciated by the skilled artisan from the following description of illustrative embodiments when read in conjunction with the accompanying drawings.

FIG. I shows back-scatter electron images of two different exposed faceted defects in lithium metal foils.

FIG. 2A is an x-ray tomogram of crystalline defects in an extruded lithium metal foil in plan view.

FIG. 2B is an x-ray tomogram of crystalline defects in an extruded lithium metal foil in cross-section view.

FIG. 3A is an x-ray tomogram of crystalline defects in a rolled lithium metal foil in plan view.

FIG. 3B is an x-ray tomogram of crystalline defects in a rolled lithium metal foil in cross-section view.

FIG. 4A is a μ-x-ray diffraction pattern from a lithium reference region in a lithium metal foil.

FIG. 4B is a μ-x-ray diffraction pattern from a crystalline defect in a lithium metal foil.

FIG. 5 is an area map made from 2500 μ-XRD measurements over a sample area of 500 μm by 500 μm showing the locations from which diffraction from lithium hydride originates.

FIG. 6A is an image that shows fluorescence from a laser-irradiated crystalline defect in lithium foil at low power.

FIG. 6B is an image that shows fluorescence from a laser-irradiated crystalline defect in lithium foil at high power.

FIG. 7 shows Raman spectra from lithium hydride powder and a crystalline defect at the surface of lithium metal foil.

FIG. 8 is a backscattered electron image of defects in a lithium metal foil.

FIG. 9 shows elemental maps for carbon, nitrogen and oxygen in a lithium metal foil.

FIG. 10 is a graph that shows the density of crystalline defects found in lithium metal foils from four commercial suppliers.

FIG. 11 shows x-ray tomograms of damage in a polymer electrolyte near a crystalline defect in a lithium metal foil.

FIG. 12 shows an Ellingham diagram for various metal oxides.

FIG. 13 shows normal probability plots for crystalline defect size contained in lithium metal after various purification times using a gettering process.

FIG. 14 is a schematic illustration of a lithium battery cell, according to an embodiment of the invention.

### DETAILED DESCRIPTION

The embodiments of the invention are illustrated in the context of lithium metal foils in secondary battery cells. The skilled artisan will readily appreciate, however, that the materials and methods disclosed herein will have application in a number of other contexts where lithium metal with very low defect density is desirable, particularly in electrochemical applications.

These and other objects and advantages of the present invention will become more fully apparent from the following description taken in conjunction with the accompanying drawings.

All ranges disclosed herein are meant to include all ranges subsumed therein unless specifically stated otherwise. As used herein, “any range subsumed therein” means any range that is within the stated range.

All publications referred to herein are incorporated by reference in their entirety for all purposes as if fully set forth herein.

Definitions—the term “lithium metal foil” is used herein to mean a very thin sheet of lithium metal, usually made by extrusion or by rolling.

### Evidence for Defects in Li Metal Foils

Lithium foils were obtained from six industry suppliers in several countries. Various analytical methods were used to study these foils including focused ion beam (FIB) sample preparation, scanning electron microscope (SEM) imaging, x-ray tomography, μ-x-ray diffraction, fluorescence, Raman spectroscopy, and backscattered electron imaging. The results of these studies are presented below.

FIG. I shows two back-scatter electron images of faceted defects in lithium metal foils. FIB has been used to expose the defects, and much of the surrounding lithium metal material has been removed. The defects have six non-orthogonal facets.

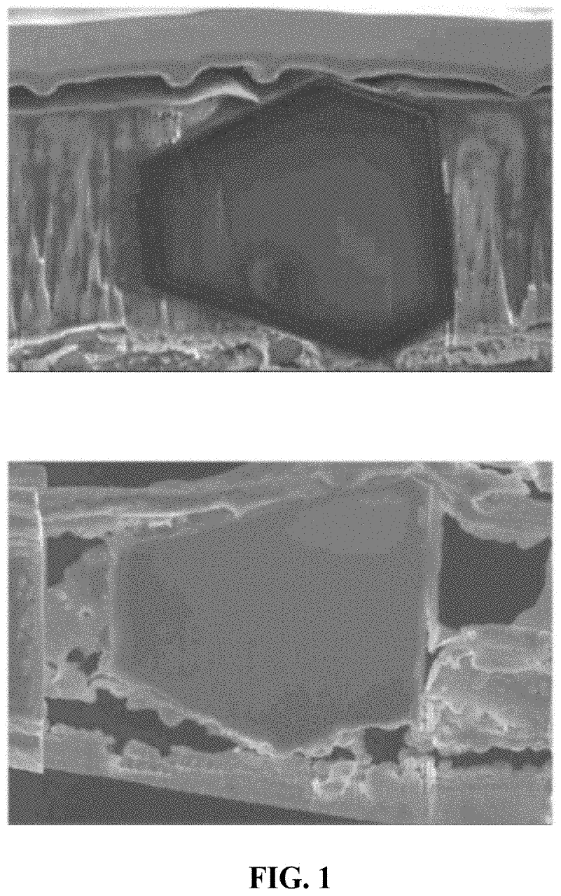

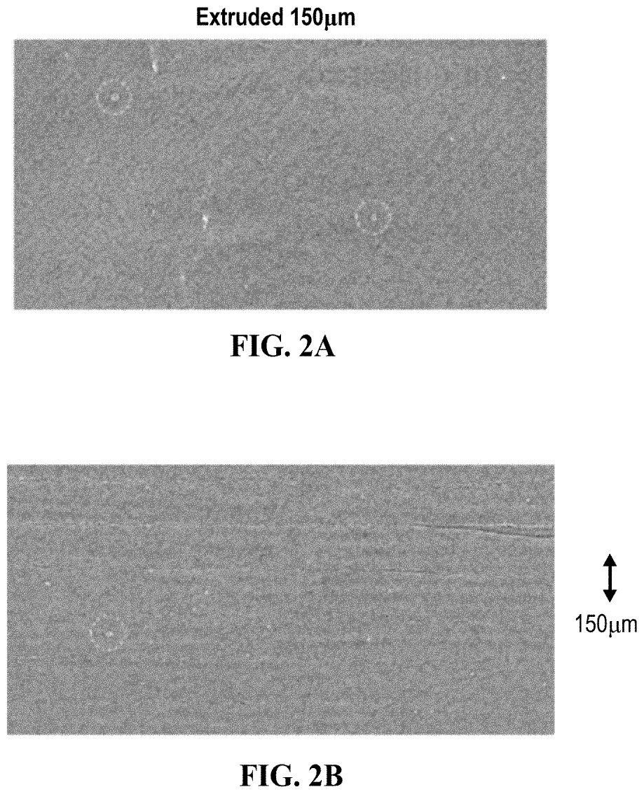

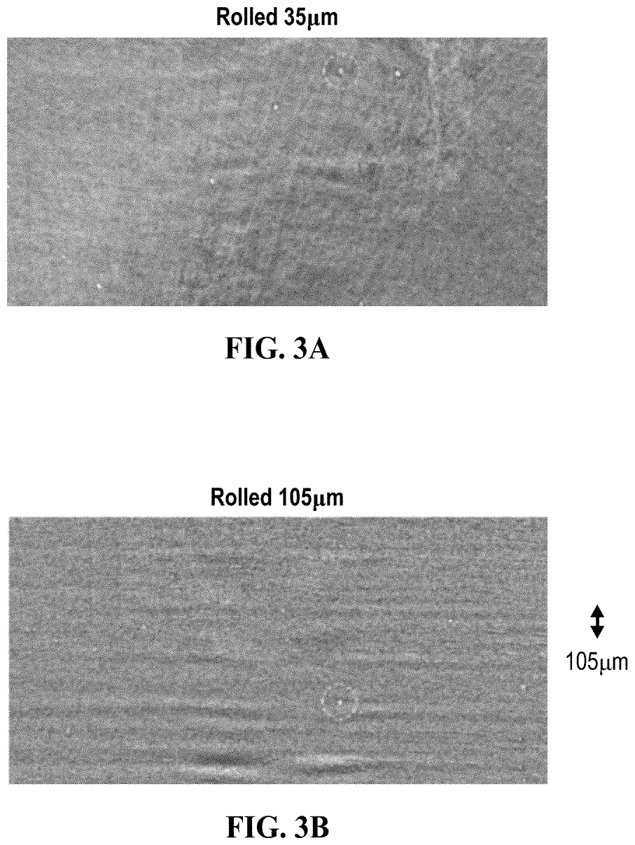

X-ray tomography was performed using the Advanced Light Source at Lawrence Berkeley National Laboratory in Berkeley, Calif. The x-ray energy was 23 keV. Other conditions include use of a 5× objective, 180° rotation, minimum 19% transmission, and 100 mm distance between the sample and the scintillator. Battery-grade lithium foils from a variety of industrial suppliers were analyzed. Some foils were extruded and some foils were rolled. The foil thicknesses ranged from 30 μm to I00 μm, and the widths of the samples (3 to 5 mm) were significantly narrower than the lengths of the foils (55 mm to 100 mm). The foils were vacuum sealed in a laminate polymer-metal pouch. To avoid capturing material from the pouch, volumes sampled in the tomograms were smaller than the volumes of the foils. Representative results are shown in FIGS. 2 and 3.

FIG. 2A is an exemplary x-ray tomogram of crystalline defects in an extruded lithium metal foil in plan view, and FIG. 2B is an exemplary x-ray tomogram of crystalline defects in an extruded lithium metal foil in cross-section view. FIG. 3A is an exemplary x-ray tomogram of crystalline defects in a rolled lithium metal foil in plan view, and FIG. 3B is an exemplary x-ray tomogram of crystalline defects in a rolled lithium metal foil in cross-section view. The grey scale in the images shown in FIGS. 2A, 2B, 3A, 3B correlates with electron density. Most of the samples seen in the images is lithium metal. Circled areas highlight some bright portions (higher electron density) that appear to be faceted and which look similar in all images. The faceting suggests that the bright portions are crystalline defects. In all the samples examined, the largest faceted defects were on the order of 10,000 μm³ (0.00001 mm³). Defects smaller than about 10 μm³ could not be observed with this method as such sizes are below the resolution of the instrument.

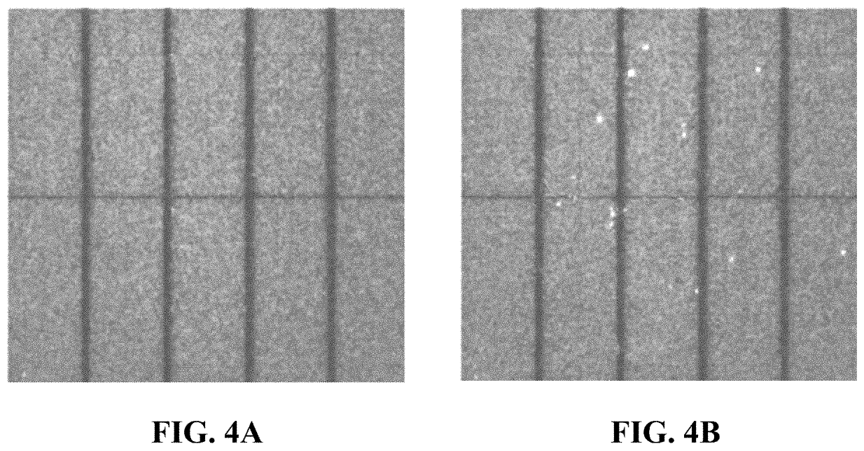

Micro x-ray diffraction (μ-XRD) was performed using Beamline 12.3.2 at the Advanced Light Source, Lawrence Berkeley National Laboratory (ALS, LBNL). Diffraction spots were obtained from two sites within 50 μm of one another in a 60-μm-thick, rolled lithium metal foil. FIG. 4A is a μ-x-ray diffraction pattern from a lithium reference region in a lithium metal foil with indices identified for some spots. The spots are consistent with identification as lithium metal. Taken from a second region within 50 μm of the lithium reference region, FIG. 4B is a μ-x-ray diffraction pattern from a crystalline defect in a lithium metal foil with indices identified for some spots. The spots are consistent with identification as lithium hydride, which has a face-centered cubic crystal structure with a lattice constant of 0.408 nm.

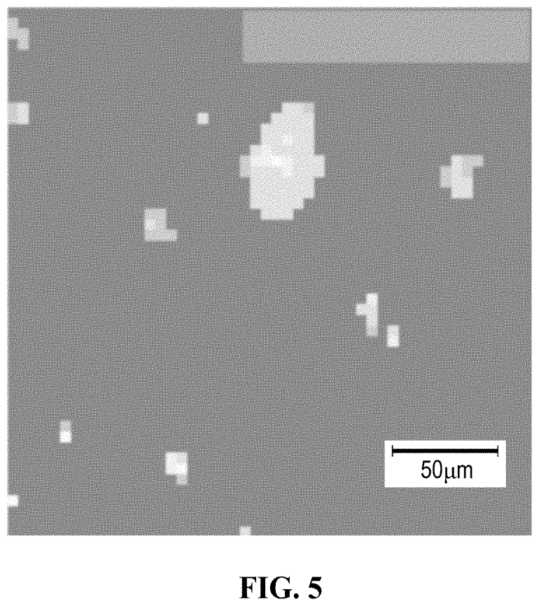

FIG. 5 is an exemplary area map of 2500 μ-XRD measurements, which was made by analyzing a sample volume of about 500 μm×500 μm×60 μm. The map shows the locations from which diffraction from lithium hydride originate, indicating the location and extent of several lithium hydride crystallites. The crystallites that have been detected in these measurements vary in size from about a few microns to about 70 μm. It was found that the density of the defects varies from less than about 200/mm³ to more than 1300/mm³.

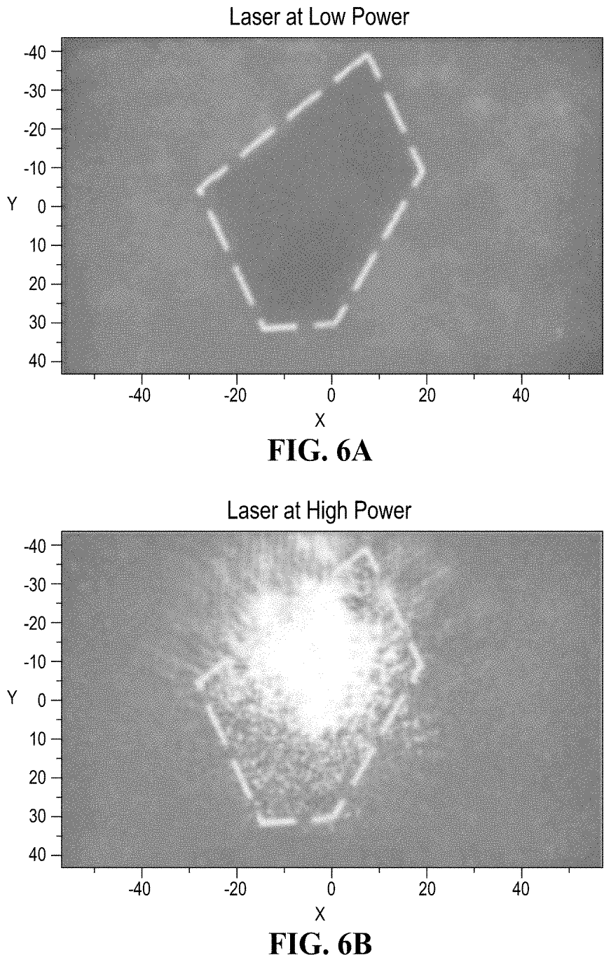

Fluorescence experiments were performed on a defect in a rolled lithium metal foil using a LabRam J-Y spectrometer equipped with a BX40 Olympus microscope in backscattering geometry (180°), aHeNe laser (633 nm wavelength) with a spot size of about 1 μm, and a 600 gr/mm grating. The results are shown in the images in FIGS. 6A and 6B, which show fluorescence from a laser-irradiated crystalline defect (lithium hydride) particle embedded in the lithium metal foil. At a (low) laser intensity of 63 mW/cm³ FIG. 6A shows reflection of laser light from the defect (note that this is easier to see in the color image submitted with the provisional application to which this application claims priority—U.S. 62/640,025 filed Mar. 8, 2019). At a (higher) laser intensity of 625 W/cm³, FIG. 6B shows that the light coming from the defect overlaps the reflection seen in FIG. 6A. The light from the defect in FIG. 6B comes from a larger area than the 1 μm spot size of the laser, which is consistent with fluorescence being emitted by the particle (note that this is easier to see in the color image submitted with the provisional application to which this application claims priority—U.S. 62/640,025 filed Mar. 8, 2019). The extent of the fluorescing particle is brighter than the surrounding lithium and has been approximated by a dotted line in both images. The intensity of the fluorescence is greater when the higher power laser is used.

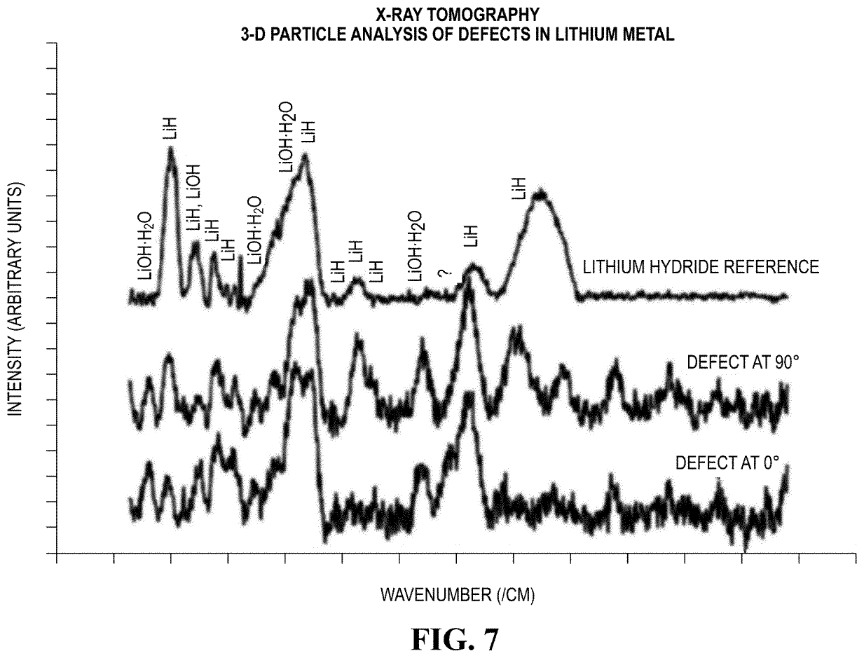

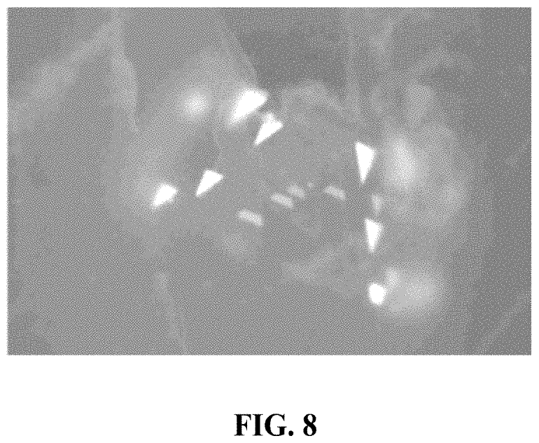

Raman spectroscopy was performed on both rolled and extruded lithium foils, and the spectra are shown in FIG. 7. The spectra in FIG. 7 include one taken at 0° from a defect on the surface of a lithium metal foil, one taken at 90° from a defect on the surface of a lithium metal foil, and one from a purchased lithium hydride powder (lithium hydride reference). There is a reasonable match in spectral features between the lithium hydride powder and the defect at 0°. Additional matches in spectral features can be found between lithium hydride reference spectrum and the defect at 90°. The backscattered electron image in FIG. 8 shows defects that were found in a rolled lithium metal foil. The bright and sharply-outlined polyhedral images are from defects that are close to the surface, and the darker and less sharply-outlined polyhedral images are from defects that are inside the lithium metal foil. Although the sample was exposed to air during transfer into the electron microscope, it is important to note that at least the defects inside the lithium metal foil are not likely to be affected by such a short exposure to air.

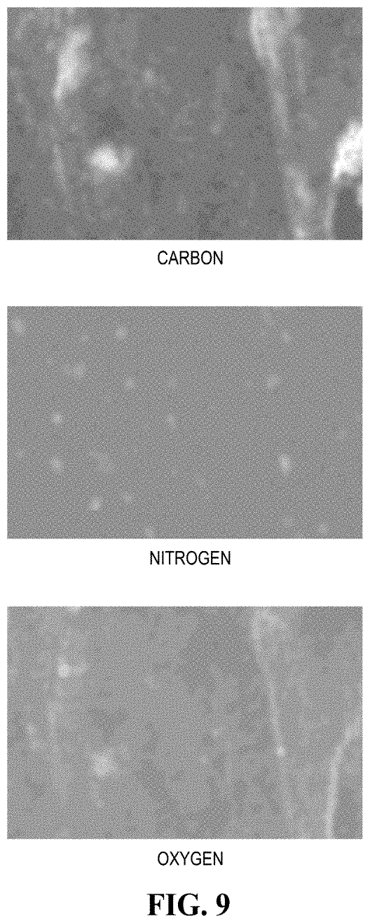

FIG. 9 shows elemental maps for carbon, nitrogen, and oxygen, which were made in a SEM (scanning electron microscope) operated at 30 keV and using an energy-dispersive x-ray detector. Hydrogen cannot be detected using this method. The maps show that there are specific regions of carbon concentration, of nitrogen concentration, and of oxygen concentration, indicating the likelihood that these elements are part of discrete defects as they are not distributed uniformly throughout the lithium metal foil.

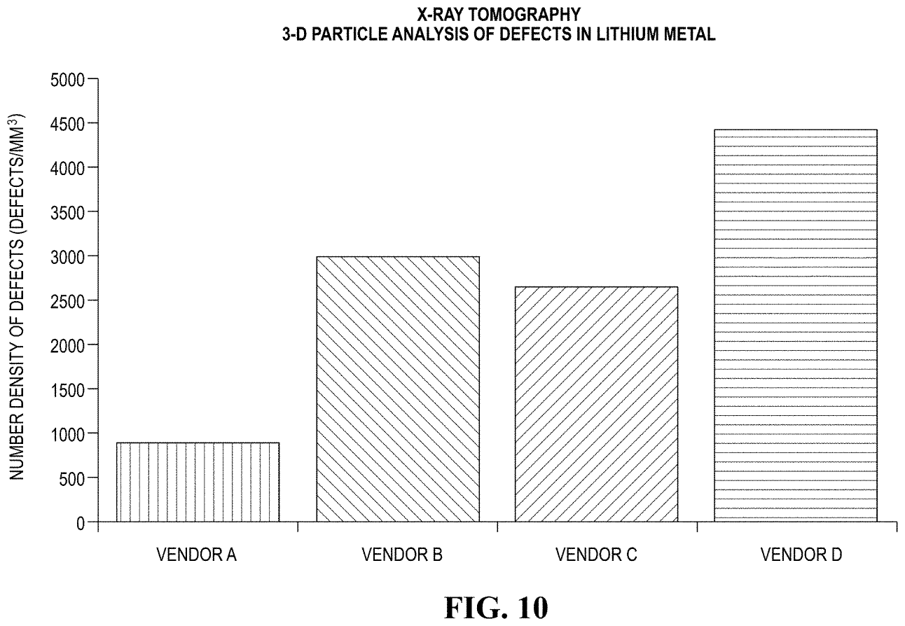

Defect densities in lithium metal foils purchased from four commercial sources, as measured using x-ray tomography, are shown in FIG. 10. The number of defects ranged from several hundred to more than 4000 per unit cubic millimeter. The composition of the defects may include lithium hydride, lithium hydroxide, lithium carbonate, lithium nitride, and/or lithium oxide.

### The Effect of Lithium Defects in a Lithium Secondary Battery

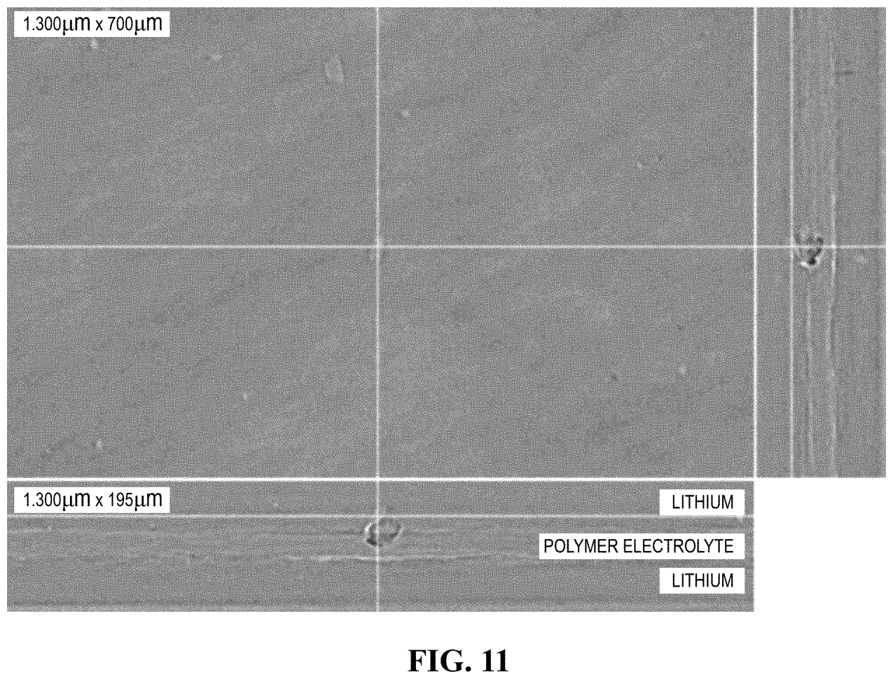

A lithium metal symmetric cell was constructed with a 60 μm-thick, rolled lithium metal foils as anode and cathode and a polymer electrolyte as the separator. The cell was cycled at 100 μA/cm², with 7 μm of lithium transferred throughput per cycle. FIG. 11 shows orthogonal tomograms in the region of a crystalline defect in the lithium metal foil of the cell. The x-ray tomography was made using 23 keV x rays, a 5× objective, more than 19% transmission, 180° rotation, and a 100 mm scintillator to sample distance. The large image is a plan view of the lithium metal foil. The same voxel appears at intersection of white lines in each cross section. Thin white lines represent the planes for orthogonal images.

There is a disturbed region in the electrolyte adjacent to the defect in the lithium metal foil. Such disturbed regions are not observed elsewhere in the cell. As a cell continues to be cycled, the disturbed region in the electrolyte can grow and eventually can extend through the entire thickness of the electrolyte. Once the disturbed region reaches the opposite electrode (or more precisely, once numerous disturbances span the electrolyte), the cell has a short circuit pathway and may fail.

As a secondary lithium battery (with a lithium metal anode) cell cycles, lithium leaves the anode as the cell discharges and is electroplated back onto the anode as the cell charges. It has been shown that the morphology of such electroplated lithium is influenced greatly by the current density at the anode. Plated lithium metal is smoother when deposited at low current densities than at high current densities. It has been shown that as the limiting current density of an electrolyte. i.e., the current density at which the ion concentration near the electrode approaches zero, is reached and exceeded, the morphology of electroplated lithium changes drastically, becoming less dense and more uncontrolled. At this current density, the electrochemical plating rate of the ions is greater than that which can be supported by electrolyte ion transport properties, leading to salt depletion.) The mechanism for this uncontrolled plating is not well understood, but it could be that as salt concentration approaches zero, there is an overpotential to move charge across this zone that has little or no salt. This overpotential is manifested as a high local electric field, which can result in electrochemical degradation of the electrolyte in addition to the nonuniform plating. The electrolyte degradation may further influence the uncontrolled plating. It is expected that operating a lithium ion cell below the limiting current density will minimize the amount of uncontrolled lithium plating.

Defects that contain lithium hydride, lithium hydroxide, lithium carbonate, lithium nitride, and/or lithium oxide, as described above, are less electronically conductive (more insulating) than lithium metal. When such defects or insulating regions are on or near the surface of a lithium metal anode, they affect the local current density distribution during lithium plating. Because lithium ions cannot plate onto the insulating regions, the current density in in the electrolyte at those regions is zero. In general, the current density adjacent to such insulating regions may be higher than the average current density across the anode. In this way, although a cell may be operating below its limiting current density, there may be regions near such insulating defect regions in which the local current density exceeds the limiting current density. The larger the insulating regions, the larger the local current density adjacent to them. Factors that contribute to determining a largest acceptable defect size include average applied current density and transport properties of the electrolyte. It is advantageous if there is no local current density that exceeds the limiting current density for the cell. Thus a largest acceptable insulating defect size, i.e., a largest size below which cell shorting is unlikely to occur as a cell cycles, can be determined.

As shown in Table I below, the electronic conductivities of materials that most likely make up the faceted defects are different from the electronic conductivity in lithium metal. Such a difference changes the distribution of potential across the lithium metal electrode surface and affects the uniformity of transfer of charge in the region of the defect. Such differences may cause undesirable electrochemical reactions and/or inconsistent plating and stripping of lithium around the defects.

TABLE I

| Material | Electronic Conductivity |
|---|---|
| lithium metal | 1.1 × 10⁷ Sim |
| lithium hydride | 1.6 × 10⁻⁹ S/m |
| lithium hydroxide | <1 O − S Sim |
| lithium carbonate | <1 O − S Sim |
| lithium nitride | 2 × 10⁻² s lm |
| lithium oxide | <1 O − S Sim |

### Controlling the Defect Density in Lithium Metal

Lithium metal is commonly purified either electrolytically or by evaporation (sometimes described as distillation). Both processes target total purity based on a moderate number of elements, usually no more than 12. The most commonly-identified elements included in manufacturers' purity specifications include some or all of Li, Na, K, Ca, Fe, N, Si, Cl, Al, Ni, and Cu. For example, the following are specification for battery grade lithium offered by some major suppliers:

| Supplier A | Supplier B |
|---|---|
| Li > 99.8 % | Li 99.90 wt % min |
| Na max. 200 ppm | Na 80 wppm max |
| K max. 100 ppm | Ca 100 wppm max |
| Ca max. 200 ppm | K 100 wppm max |
| N max. 300 ppm | Fe 15 wppm max |
| | Si 100 wppm max |
| | Cl 50 wppm max |
| | N 300 wppm max |

In spite of control of these impurities, faceted defects, which may include lithium hydride, lithium hydroxide, lithium carbonate, lithium nitride, and/or lithium oxide, are still found in such commercially-available lithium metal foils. As can be seen from the exemplary specifications above, hydrogen, carbon, nitrogen, and oxygen are not elements whose concentrations are specified, implying that such elements are not specifically controlled, measured, or removed.

In some embodiments of the invention, methods are provided to reduce the hydrogen, carbon, nitrogen, and/or oxygen concentration in a lithium metal foil. Examples or methods that can be used include, but are not limited to, distillation, melt-separation, electrolysis, and gettering reactions (hot traps). Several getter materials, such as yttrium, zirconium, and calcium, can reduce the amount of hydrogen, nitrogen, and oxygen in a lithium melt. Temperature, vacuum pressure, mass ratios, surface area ratios, and the design and dimensions of the apparatus are conditions that affect the gettering processing. In various embodiments, temperatures between 350° C. and 550° C. and pressures less than 10-⁵ mbar are used in a gettering process. In various embodiments, a mass ratio of getter material to lithium ratio ranges from 0.1 to 0.25.

There are several materials that can getter impurities from molten lithium. An Ellingham diagram of a reaction's free energy versus temperature can identify the best candidates. Hot-trap metals, directly or indirectly exposed to molten lithium, preferentially react with unwanted impurities in lithium such as oxygen, nitrogen, and hydrogen. The mechanism may be the chemical reaction of lithium hydrides, nitrides, and/or oxides by metals that are more reactive.

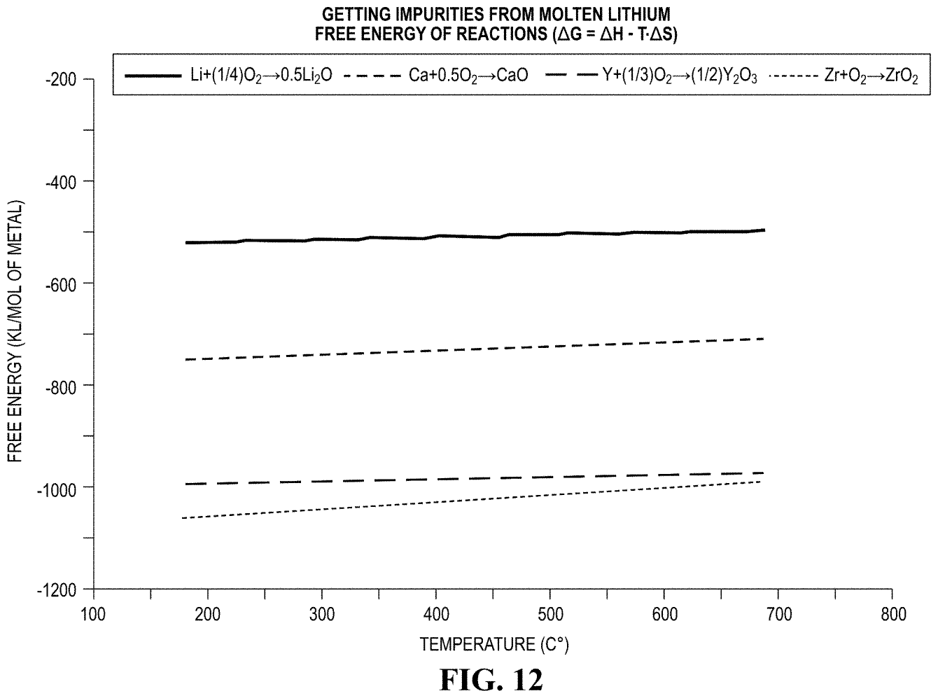

FIG. 12 is a graph that shows the free energy for several gettering reactions, and indicates that getter materials such as calcium, zirconium, and yttrium can react with oxygen in reactions that are more thermodynamically than formation of lithium oxide. As oxygen in molten lithium is more likely to form oxides with such getter materials, it is less available to form oxides with lithium, and the overall concentration of oxygen in the molten lithium is reduced. The oxidized getter materials can be separated from the molten lithium, which can then be cooled to form lithium metal foils with few or no lithium oxide crystalline defects.

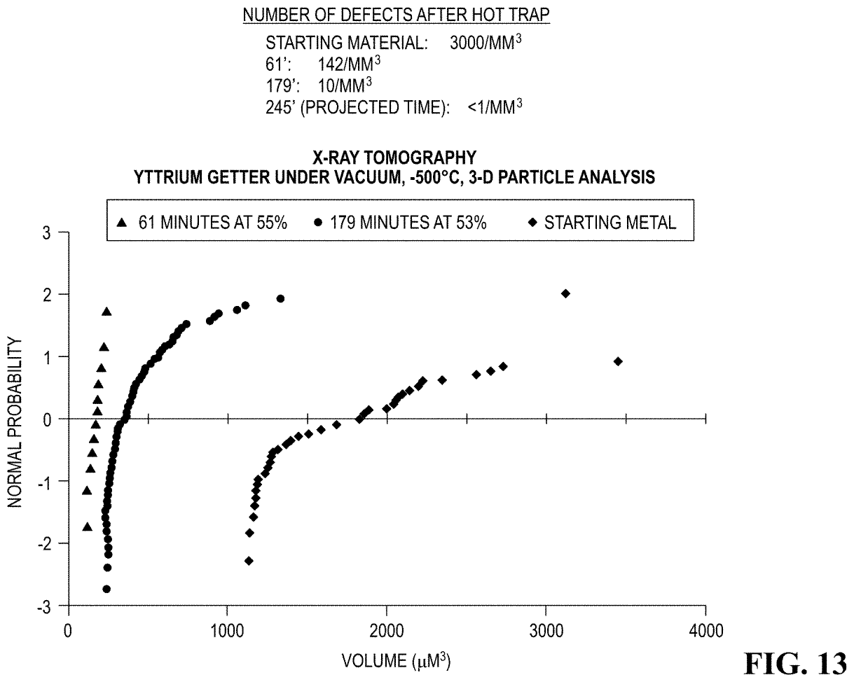

In an exemplary embodiment, a simple hot trap process was used at a temperature of 550° C. with molten lithium that contained a yttrium to lithium mass ratio of 0.25 to 1. Some of the molten lithium was processed for 60 minutes, and some molten lithium was processed for 180 minutes. The pure yttrium and the reacted yttrium were separated from the lithium by gravity settling. The molten lithium was then cooled and the yttrium-containing material that had settled out was removed, leaving only purified lithium. Lithium metal foils were formed by pressing the purified lithium. X-ray tomography was performed on the lithium metal foils to determine their crystalline defect densities. The results are shown in FIG. 13. The unpurified lithium contained about 3000 defects per cubic millimeter, and the average size of the defects was about 1800 μm³. The lithium metal that was processed for 60 minutes contained about 142 defects per cubic millimeter, and the average size of the defects was about 350 μm³. The lithium metal that was processed for 180 minutes contained about 10 defects per cubic millimeter, and the average size of the defects was about 180 μm³. The yttrium gettering process decreased the number of crystalline defects in the lithium by at least a factor of 300. Longer gettering processing further decreases the density of crystalline defects and decrease the average volume of crystalline defects. Given the rate of crystalline defect decrease observed, it can be predicted that a processing time of more than 245 minutes will result in a crystalline defect density of less than 1 defect per cubic millimeter with a size small enough to be undetectable by current observation techniques.

TABLE II

| | Defect size | Defect size | Defect size |
|---|---|---|---|
| | distribution with | distribution with | distribution with |
| Defect size | no getter | 60 minute getter | 180 minute getter |
| category | processing | processing | processing |
| <167 μm³ | 0% | 0% | 46% |
| 167 < v < 300 μm³ | 0% | 40% | 54% |
| >300 μm³ | 100% | 60% | 0% |
| Total defect | 3000/mm³ | 142/mm³ | 10/mm³ |
| density: | | | |

In another embodiment of the invention, techniques for removing crystalline defects with getter materials involves mechanical mixing of molten lithium with particles of getter material (e.g., calcium, zirconium, yttrium, and others as discussed above) and then filtering to remove the getter particles. Similarly, molten lithium may be passed through a packed bed of getter material or pumped through a mesh made of getter material. Other contact mechanisms where pipes or containers are constructed of getter material may also be used to make contact between molten lithium and getter material. Essentially, any mechanism that effects contact between a getter material and molten lithium may be employed to ensure that getter materials react with and remove trace elements such as oxygen, nitrogen, and hydrogen from molten lithium. The reaction products of the getter materials with oxygen, nitrogen, and/or hydrogen materials can be removed, leaving purified lithium with a reduced density of lithium-based crystalline defects in lithium metal foils made therefrom.

In a secondary lithium battery cell, even just one defect at the surface of a lithium foil anode can lead to formation of a lithium shunt in the separator electrolyte that can cause a short circuit path as a cell cycles. It is known that lithium shunts that can lead to shorting may burn off or self-heal instead due to the large amount of current that can pass through such narrow shunts. When such a burn-off process occurs, shunts are less likely to lead to cell death. However, if a sufficient number of shunts are present at the same time and maintained, short circuit current is distributed among them instead of being concentrated on just one shunt, and the shunts are less likely to burn off or self-heal. Under such conditions a cell may not be able to recover, and it may fail due to poor coulombic efficiency and self-discharge. Thus, although some shunts can be tolerated without causing significant damage to a cell, it is still important to minimize the number of such defects that can lead to shunts that can form short circuit pathways.

Lithium Metal Foils with Ideal Crystalline Defect Densities

In an exemplary embodiment, a lithium metal secondary battery cell with a capacity of 10 Ah has a lithium foil surface area of 1.35 m². One crystalline surface defect with a size of 20 or more can cause a short circuit path during cycling. For an idealized completely defect-free cell manufacturing yield of 99%, i.e., 99% of cells do not contain a single detectable crystalline surface defect that can cause a lithium shunt, the lithium metal foil used in the cells can have no more than I defect per 135 m².

In another exemplary embodiment, a lithium metal secondary battery cell has a lithium foil thickness of 20 μm, corresponding to a lithium volume per cell of I 0¹³ μm³ One crystalline surface defect with a size of 20 μm (approximate volume of 8000 μm³) or more can cause a short circuit path during cycling. For an idealized, completely defect-free manufacturing yield of 99%, i.e., 99% of cells do not contain a single detectable crystalline defect that can cause a lithium shunt, the lithium metal foil used in the cells can have no more than I defect with a size of 20 μm or more per 1.35×10⁶ mm₃.

Lithium Metal Foils with Pragmatic and Acceptable Crystalline Defect Densities

In an exemplary embodiment, a lithium metal secondary battery cell has a non-zero but acceptable self-discharge rate governed by a density of lithium shunts that have formed adjacent to crystalline defects. Typical self-discharge for lithium ion chemistries are in the range of 3-5% of cell capacity per month. With this same pragmatic boundary limit, lithium metal cells may have a certain shunt defect density which results in the same self-discharge rate (5% per month). Given a 10 Ah cell with a lithium metal anode and a LFP (lithium ferrous phosphate) cathode, over one month, a 5% self-discharge would occur with a total shunt resistance of approximately 4.2 kohms. Given that the shunts that may form in the separator electrolyte are made of lithium metal and are approximately the same cross sectional area as the 20 μm crystalline defects in the lithium foil (approximate volume of 8000 μm³ for a 20 μm thick separator), the total shunt resistance that would occur with a crystalline defect surface density in the lithium foil of about 1 per mm² or a volumetric density of 100 per mm³ may be acceptable from a self-discharge and cell efficiency perspective. Such an allowable crystalline defect density is a limit that is easier to achieve and offers a pragmatic alternative to an ideal crystalline defect density limit, which is very difficult to achieve. Nevertheless, such a pragmatic limit is still much lower (by orders of magnitude) than what is currently available in any commercially-available lithium foil. The purification processes discussed herein have produced lithium foil with crystalline defect densities below this pragmatic limit.

### Lithium Metal Foils in Electrochemical Cells

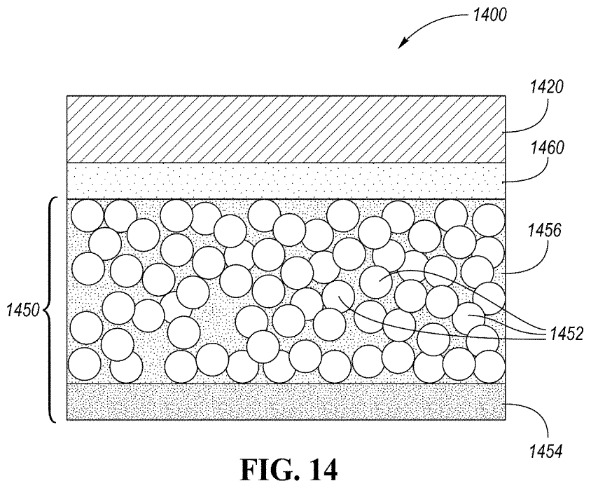

In another embodiment of the invention, the lithium metal material described herein is used as an anode in a battery cell. With reference to FIG. 14, a lithium battery cell 1400 has such an anode (negative electrode) 1420 that is configured to absorb and release lithium ions. The lithium battery cell 1400 also has a cathode (positive electrode) 1450 that includes cathode active material particles 1452, an electronically-conductive additive (not shown), a current collector 1454, a catholyte 1456, and an optional binder (not shown). There is a separator region between the anode 1420 and the cathode 1450. The separator region contains a separator electrolyte 1460 that facilitates movement of lithium ions back and forth between the anode 1420 and the cathode 1450 as the cell 1400 cycles. The catholyte 1456 and the separator electrolyte 1460 may or may not be the same. The catholyte 1456 and the separator electrolyte 1460 may be any electrolyte that is suitable for such use in a lithium battery cell. In one arrangement, the separator electrolyte 1460 contains a liquid electrolyte that is soaked into a porous plastic material (not shown). In another arrangement, the catholyte 1456 and/or the separator electrolyte 1460 contains a viscous liquid or gel electrolyte. In another arrangement, the catholyte 1456 and/or the separator electrolyte 1460 contains a solid polymer electrolyte. In another arrangement, the catholyte 1456 and/or the separator electrolyte 1460 contains a ceramic electrolyte. If different electrolytes are used for the catholyte 1456 and the separator electrolyte 1460, it is useful if the catholyte 1456 and the separator electrolyte 1460 are immiscible.

A polymer electrolyte may also include electrolyte salt(s) that help to provide ionic conductivity. Any of the polymer electrolytes described herein may be liquid or solid, depending on molecular weight. Examples of useful Li salts include, but are not limited to, LiPF6, LiBF4, LiN(CF3SQ2)2, Li(CF3SQ2)3C, LiN(SO2CF2CF3)2, LiB(C2Q4)2, Li2B12FxH12-x, Li2B12F12, LiTFSI, LiFSI, and mixtures thereof. Examples of solid polymer electrolytes include, but are not limited to, block copolymers that contain ionically-conductive blocks and structural blocks that make up ionically-conductive phases and structural phases, respectively. The ionically-conductive phase may contain one or more linear polymers such as polyethers, polyamines, polyimides, polyamides, poly alkyl carbonates, polynitriles, perfluoro polyethers, fluorocarbon polymers substituted with high dielectric constant groups such as nitriles, carbonates, and sulfones, and combinations thereof. In one arrangement, the ionically-conductive phase contains one or more phosphorous-based polyester electrolytes, as disclosed herein. The linear polymers can also be used in combination as graft copolymers with polysiloxanes, polyalkoxysiloxanes, polyphosphazines, polyolefins, and/or polydienes to form the conductive phase. The structural phase can be made of polymers such as polystyrene, hydrogenated polystyrene, polymethacrylate, poly(methy1 methacrylate), polyviny1pyridine, polyviny1cyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, poly(phenylene oxide), poly(2,6-dimethyl-1,4-phenylene oxide), poly(phenylene sulfide), poly(phenylene sulfide sulfone), poly(phenylene sulfide ketone), poly(phenylene sulfide amide), polysulfone, fluorocarbons, such as polyvinylidene fluoride, or copolymers that contain styrene, methacrylate, or vinylpyridine. It is especially useful if the structural phase is rigid and is in a glassy or crystalline state.

Suitable cathode active materials include, but are not limited to, LFP (lithium iron phosphate), LMP (lithium metal phosphate in which the metal can be Mn, Co, or Ni), V2Os (divanadium pentoxide), NCA (lithium nickel cobalt aluminum oxide), NCM (lithium nickel cobalt manganese oxide), high energy NCM (HE-NCM-magnesium-rich lithium nickel cobalt manganese oxide), lithium manganese spinel, lithium nickel manganese spinel, and combinations thereof. Suitable electronically-conductive additives include, but are not limited to, carbon black, graphite, vapor-grown carbon fiber, graphene, carbon nanotubes, and combinations thereof. A binder can be used to hold together the cathode active material particles and the electronically conductive additive. Suitable binders include, but are not limited to, PVDF (polyvinylidene difluoride), PVDF-HFP poly (vinylidene fluoride-co-hexafluoropropylene), PAN (polyacrylonitrile), PAA (polyacrylic acid), PEO (polyethylene oxide), CMC (carboxymethyl cellulose), and SBR (styrene-butadiene rubber).

Any of the polymer electrolytes described herein may be liquid or solid, depending on molecular weight.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself

We claim:

1. A method of reducing defect density in a lithium metal foil, comprising;
providing molten lithium metal;
adding a gettering material to the molten lithium metal;
holding the molten lithium metal at a temperature of 550° C. for at least 180 minutes; separating the molten lithium from the getter material by filtration;
casting the molten lithium to form an ingot; and
extruding the ingot to form a foil.

2. The method of claim 1, further comprising rolling the foil to reduce its thickness.
